(19) United States
(12) Patent Application Publication
(10) Pub. No.: US 2016/0314482 A1
(43) Pub. Date: Oct. 27, 2016

(54) DETERMINATION OF RESOURCE PROVIDER CONDITIONS USING TRANSACTION DATA

(71) Applicants: Gourab Basu, Half Moon Bay, CA (US); Michael Mori, San Mateo, CA (US); Ross Sakata, Foster City, CA (US); Rajat Das, Foster City, CA (US)

(72) Inventors: Gourab Basu, Half Moon Bay, CA (US); Michael Mori, San Mateo, CA (US); Ross Sakata, Foster City, CA (US); Rajat Das, Foster City, CA (US)

(21) Appl. No.: 15/139,267

(22) Filed: Apr. 26, 2016

Related U.S. Application Data
(60) Provisional application No. 62/153,356, filed on Apr. 27, 2015.

(51) Int. Cl. G06Q 30/02

(52) U.S. Cl. CPC G06Q 30/0202; G06Q 30/0251; G06Q 30/0207

(57) ABSTRACT

A server computer may receive a request from a user device of a user for a wait time associated with a merchant. The server computer may receive information comprising dynamic and static data from various entities. The information may include at least transaction data. The server computer may utilize the information to determine a wait time prediction and other conditions associated with the merchant. The determined information may be presented to the user by a notification on the user device.

### CROSS-REFERENCES TO RELATED APPLICATIONS

This application claims priority from Provisional U.S. Patent Application No. 62/153,356, filed on Apr. 27, 2015, the disclosure of which is herein incorporated by reference in its entirety for all purposes.

### BACKGROUND

Wait times can be long at merchant institutions or other commercial establishments during peak time. For example, many restaurants typically have long wait times around lunch hours. Consumers may be pressed for time and may want to avoid having to wait for long periods. However, there is no comprehensive way to predict in real time how long a wait time will be, or other conditions associated with a merchant.

Embodiments of the invention address this and other problems, individually and collectively.

### BRIEF SUMMARY

Embodiments of the present invention are directed to systems and methods for predicting merchant conditions utilizing at least transaction data.

According to one embodiment of the invention, a server computer can receive a request from a user device of a user for a first wait time associated with a first merchant. The server computer can retrieve information including at least transaction data (e.g., payment data) and then utilize the information to calculate the first wait time corresponding to the estimated amount of time a user may have to wait before the user can access a good or service, or conduct a transaction at the first merchant. The server computer can subsequently send to the user device a first notification comprising the first wait time and a second merchant associated with a second wait time. In some embodiments, the second wait time is shorter than the first wait time.

According to a second embodiment, a method is provided in which a wait time may be estimated. The method comprises receiving a request from a user of a user device for a wait time and identifying a plurality of resource providers related to the received request. The method further comprises retrieving transaction data associated with the plurality of resource providers, the transaction data indicating a number of authorization requests submitted by each of the plurality of resource providers. The method further comprises calculating a wait time for each of the plurality of resource providers, and sending a notification including the wait times to the user device.

In some embodiments, the transaction data includes current transaction frequency, current transaction volume, and average ticket price.

In some embodiments, the server computer can further receive location information associated with the user device and can utilize the location information to calculate the first wait time. In some implementations, the server computer can determine whether the location information indicates the user device is within a proximity region.

In some embodiments, the server computer can further send to the user device a second notification comprising an offer that can be utilized at the second merchant. In some implementations, the second notification can be an early notification indicating to the user to start heading to the second merchant within a time period in order to conduct a transaction at the second merchant by a certain time.

Embodiments of the invention are further directed to a server computer comprising a processor and a memory element. The memory element can comprise code, executable by the processor, for implementing any of the methods described herein. Embodiments of the invention are further directed to a system comprising the server computer, a user device, and an access device, wherein the user device and access device are in communication with the server computer.

These and other embodiments of the invention are described in further detail below.

### BRIEF DESCRIPTION OF THE DRAWINGS

FIG. 1 illustrates a block diagram of an exemplary system with at least some of the components for implementing embodiments of the invention;

FIG. 2 shows a flowchart of a method according to embodiments of the present invention;

FIG. 3 shows exemplary data according to embodiments of the present invention;

FIG. 4 shows an exemplary early notification according to embodiments of the present invention;

FIG. 5 shows an exemplary environment according to embodiments of the present invention;

FIG. 6 shows exemplary data according to embodiments of the present invention;

FIG. 7 depicts a data flow illustrating an example technique for providing an estimation of wait time in accordance with at least some embodiments of the disclosure;

FIG. 8 depicts a flow diagram illustrating an example process 800 for identifying a wait time to be presented to a user; and

FIG. 9 depicts a flow diagram illustrating an example process for identifying a wait time to be presented to a user based on transaction pattern data.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Prior to discussing embodiments of the invention, description of some terms may be helpful in understanding embodiments of the invention.

An “adoption rate” may be any indication of a number of people that have “adopted” or utilized an application or program. An adoption rate may be a percentage of the population that has downloaded and/or executed a mobile application. In some embodiments, the adoption rate may be calculated with respect to a particular location and/or segment of the population. For example, an adoption rate may be calculated by zip code based on the number of people that have downloaded an application divided by the total number of users (e.g., mobile phone owners) in that zip code.

An “authorization request message” may be any suitable message that requests authorization for a transaction. An authorization request message may be an electronic message that is sent to a payment processing network and/or an issuer of a payment account to request authorization for a payment transaction. An authorization request message according to some embodiments may comply with ISO 8583, which is a standard for systems that exchange electronic transaction information associated with a payment made by a user using an access credential or a payment account. An authorization request message may also comprise additional data elements corresponding to “identification information” including, for example, a service code, a CVV (card verification value), a dCVV (dynamic card verification value), an expiration date, etc. An authorization request message may also comprise “transaction data,” such as any information associated with a current transaction (e.g., the transaction amount, merchant identifier, merchant location, etc.) as well as any other information that may be utilized in determining whether to identify and/or authorize a payment transaction.

An “authorization response message” may be any electronic message that is a reply to an authorization request message. In some embodiments, the authorization response message may be generated by an issuing financial institution (i.e. issuer) or a payment processing network. The authorization response message may include an authorization code, which may be a code that an account issuing bank returns in response to an authorization request message in an electronic message (either directly or through the payment processing network) to a merchant's access device (e.g., point of sale terminal) that indicates approval of the transaction. The code may serve as proof of authorization. As noted above, in some embodiments, a payment processing network may generate and/or forward the authorization response message to the merchant. In some embodiments, the authorization response message may be associated with confirmation element data by a confirmation element identifier. In some cases, modified confirmation element data may be included in the authorization response message sent to an access device.

“Location data” or “geolocation data” may comprise any suitable identification of a location. For example, location information may include coordinates (e.g., grid coordinates). In this example, location information may be formatted as (X, Y) where each of X and Y represent positions along a separate axis. In some embodiments, coordinates may include a latitude and longitude. In some embodiments, a location information may also include data related to the location. For example, the location information may include a time that a person or thing was at the location. Location information may be stored in a data store with respect to a particular user, mobile device, or terminal.

A “mechanism popularity” is the frequency with which users utilize a particular mechanism. In some embodiments, a mechanism popularity may represent the frequency with which users conduct transactions using a particular payment mechanism or account type. In some embodiments, a mechanism popularity may be specific to a geographic region or location. Mechanism popularity may also vary by resource provider based on the types of mechanisms available to that resource provider.

A “mobile device” may include any suitable device that can be easily transported by user. Examples of mobile devices are described in detail below.

A “transaction” may be any interaction or exchange between two or more parties. For example, a transaction may include a first entity requesting resources from a second entity. In this example, the transaction is completed when the resources are either provided to the first entity or the transaction is declined.

A “transaction data” may be any information related to a transaction between two entities. Transaction information may include information related to a completed transaction or a transaction that has not yet been completed. In some embodiments, the transaction information may include any suitable information related to a context of the transaction. For example, the transaction information may include a time at which the transaction was conducted, a terminal at which the transaction was conducted, an amount for which the transaction was conducted, an indication of an entity with whom the transaction was conducted, or any other suitable transaction-related information. Transaction data may include data gathered from authorization requests.

A “transaction frequency” can be the number of times that a transaction is conducted by a resource provider within a period of time. Transaction frequency may be specific to a particular resource provider. In some embodiments, the transaction frequency may be calculated as a number of authorization requests received for a particular resource provider within the last X seconds, where X is a predetermined amount of time.

A “transaction pattern” can be any sequence or pattern which may provide an indication of a transaction that is to be conducted. In some embodiments, a transaction pattern may be multiple transactions that are correlated (e.g., have a high probability of occurring together). In some embodiments, a transaction pattern may be a series of transactions that are often conducted in a sequence by a user. In some embodiments, transaction patterns may represent a distribution of transactions at particular resource providers throughout an area. For example, the transaction pattern may indicate what percentage of users in an area historically conduct transactions at a particular resource provider.

Some embodiments of the invention are related to determining merchant conditions including a wait time associated with a merchant in real time based on at least transaction data. A server computer may receive information surrounding a first merchant including at least transaction data (e.g., payment data), which may include current transaction frequency, current transaction volume, and average ticket price. The server computer may utilize the information to calculate a wait time corresponding to the estimated amount of time a user may have to wait before the user can access a good or service, or conduct a transaction at the first merchant. The server computer can also send a notification to a user device of the user indicating a second merchant that may have a shorter wait time than that of the first merchant. In some cases, the server computer may utilize a location associated with the user device to determine wait times.

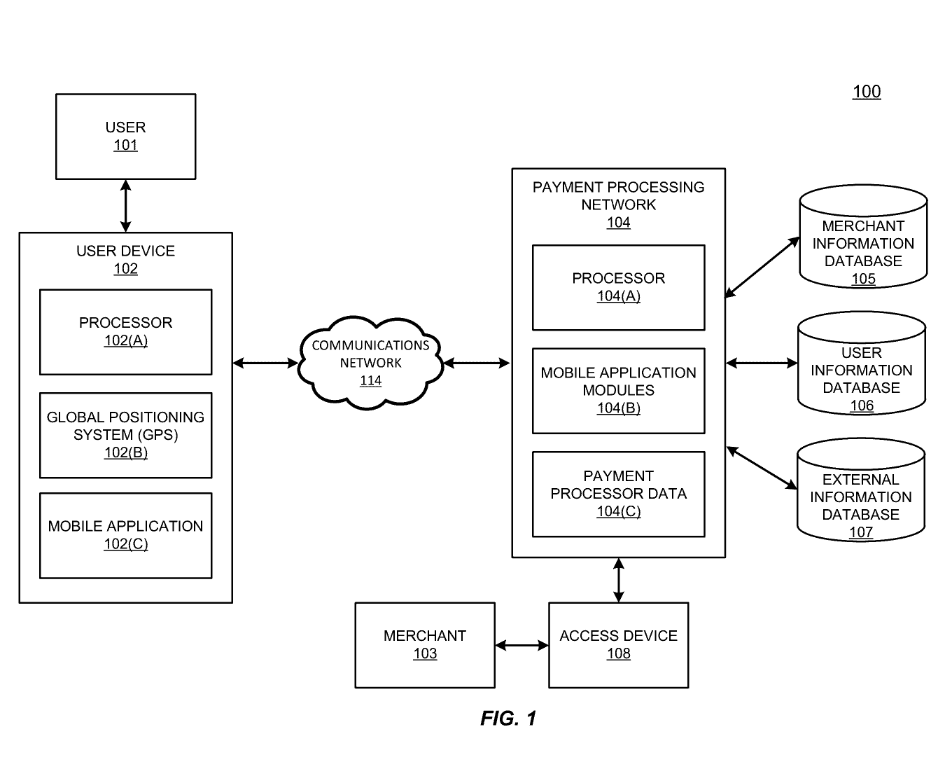

FIG. 1 illustrates an exemplary system 100 with at least some of the components for implementing embodiments of the invention. FIG. 1 includes a user 101, a user device 102, a communications network 114, a merchant 103, an access device 108, a payment processing network 104, a merchant information database 105, a user information database 106, and an external information database 107. The user device 102, which may be operated by a user 101, may communicate with the payment processing network 104 via a communications network 114. The payment processing network 104 may communicate with an access device 108 at a merchant 103. The payment processing network 104 may also store or retrieve information from the merchant information database 105, the user information database 106, and the external information database 107. User device 102 may comprise a processor 102(A), global positioning system (GPS) 102(B), and a mobile application 102(C). Payment processing network 104 may comprise a processor 104(A), mobile application modules 104(B), and payment processor data 104(C).

User 101 (which may alternatively be referred to as a consumer) may operate user device 102 to communicate information to and from payment processing network 104. User 101 may utilize user device 102 to view information (e.g., by notifications or alerts) surrounding wait times of merchants from payment processing network 104. In some cases, user 101 may select a notification (or alert) type and configure associated settings. In some embodiments, user 101 may utilize user device 102 to input information that may be sent to payment processing network 104. For example, user 101 may enter into user device 102 feedback regarding the accuracy of information (e.g., wait times) displayed by mobile application 102(C), which may be sent to and used by payment processing network 104 (e.g., to improve wait time prediction algorithm).

User device 102 may be any suitable device that has wireless communication capabilities and may be capable of conducting any methods described herein. User device 102 may comprise processor 102(A), global positioning system (GPS) 102(B), and mobile application 102(C). Instead of a global positioning system, other types of location determining systems may be present in the user device 102. Examples of such location determining systems may include systems that can provide or identify locations using cell tower strength, IP address data, Wi-Fi access point data, etc. User device 102 may be operated by user 101 and may communicate information to and from at least payment processing network 104.

Processor 102(A) may include hardware within user device 102 that carries out instructions embodied as code in a computer-readable medium (e.g., a non-transitory computer-readable medium). An exemplary processor may be a central processing unit (CPU). As used herein, a processor can include a single-core processor, a plurality of single-core processors, a multi-core processor, a plurality of multi-core processors, or any other suitable combination of hardware configured to perform arithmetical, logical, and/or input/output operations of a computing device.

Global positioning system (GPS) 102(B) may be any suitable hardware and software that can detect, store, and send location information. GPS 102(B) may detect location information of user device 102 in real-time or in periodic intervals. In some embodiments, GPS 102(B) may communicate wirelessly with other entities. For example, GPS 102(B) or other device associated with GPS 102(B) may communicate a location associated with user device 102 to a server computer, such as payment processing network 104. The location information may help the server computer predict a wait time associated with merchant 103 at which user 101 associated with user device 102 may be waiting in line.

Mobile application 102(C) may be any suitable application that may communicate information according to embodiments of the present invention. For example, mobile application 102(C) may cause the user device 102 to display a predicted wait time associated with merchant 103 to user 101, as well as wait times associated with related merchants or nearby merchants. Further, mobile application 102(C) may cause the user device 102 to display an intelligent notification (or alert). For example, the notification may indicate when user 101 should start heading to a merchant in order to conduct a transaction with the merchant by a certain time. In some embodiments, mobile application 102(C) may provide offers (e.g., discounts for takeout, etc.), promotions, and suggestions (e.g., suggest online ordering during busy days, etc.) to user 101.

In some implementations, mobile application 102(C) may comprise an interface enabling user 101 to interact with mobile application 102(C). The interface of mobile application 102(C) may enable user 101 to view any information in any suitable form. For example, the interface may display information (e.g., wait times, transaction frequency, transaction volume, throughput, etc.) associated with one or more merchants in various manners (e.g., list, ranking, graph, heat map, visualization, etc.). The interface may enable notifications to be received in any suitable manner. In some implementations, notifications may be categorized (e.g., by notification type, associated merchant, merchant type, etc.). In some cases, user 101 may utilize the interface to enter information into user device 102 that may be sent to payment processing network 104.

Some non-limiting examples of user device 102 may include mobile devices (e.g., cellular phones, keychain devices, personal digital assistants (PDAs), pagers, notebooks, laptops, notepads, smart watches, fitness bands, jewelry, etc.), automobiles with remote communication capabilities, personal computers, and the like.

Communications network 114 may comprise a plurality of networks for secure communication of data and information between entities. In some embodiments, communications network 114 may follow a suitable communication protocol to generate one or more secure communication channels for user device 102 and payment processing network 104. Any suitable communications protocol may be used for generating a communications channel. A communication channel may in some instance comprise a “secure communication channel,” which may be established in any known manner, including the use of mutual authentication and a session key and establishment of an SSL session. However, any method of creating a secure channel may be used. By establishing a secure channel, sensitive information related to user 101 and user device 102 may be securely transmitted.

Payment processing network 104 may include data processing subsystems, networks, and operations used to support and deliver authorization services, and clearing and settlement services. In some cases, payment processing network 104 may be operated by one or more server computers. An example of payment processing network 104 includes VisaNet®, operated by Visa®. Payment processing network 104 may include wired or wireless network, including the internet. In some embodiments, payment processing network 104 may be in communication with user device 102 to communicate information to user 101 by mobile application 102(C). Payment processing network 104 may comprise processor 104(A), mobile application modules 104(B), an payment processor data 104(C).

Processor 104(A) may include hardware within a computer operating payment processing network 104 that carries out instructions embodied as code in a computer-readable medium (e.g., a non-transitory computer-readable medium). An exemplary processor may be a central processing unit (CPU). As used herein, a processor can include a single-core processor, a plurality of single-core processors, a multi-core processor, a plurality of multi-core processors, or any other suitable combination of hardware configured to perform arithmetical, logical, and/or input/output operations of a computing device.

Mobile application modules 104(B) may comprise any suitable software that can enable features of mobile application 102(C). For example, mobile application modules 104(B) may comprise one or more modules that may cause the payment processing network 104 to conduct various functions (e.g., receiving and analyzing location information from GPS 102(B), retrieving and analyzing information from databases, utilizing previous information and payment processor data 104(C) to calculate wait time predictions or line speed predictions, sending notifications and predictions to user device 102, etc.). Mobile application modules 104(B) may cause the payment processing network 104 to enable information to be received, cleansed (e.g., synced, normalized, etc.), and aggregated. Mobile application modules 104(B) may also cause the payment processing network 104 to enable management of enrollment of users.

Payment processor data 104(C) (which may alternatively be referred to as payment data) may comprise any information that may be processed by payment processing network 104. For example, payment processor data 104(C) may include current (e.g., real-time) and historical transaction information and any analysis of such transaction information. In some cases, payment processor data 104(C) may include transaction volume, transaction frequency, and average ticket price. In some cases, payment processor data 104(C) may be received from access device 108 of merchant 103 (e.g., terminal identifiers, location of terminals, number of terminals in operation, other terminal data, etc.).

Payment processor data 104(C) may be utilized by mobile application modules 104(B). For example, historical transaction information may enable payment processing network 104 to determine historical trends in payment data. For example, payment processing network 104 may compare historical average payment frequency with current (e.g., real-time) payment frequency associated with a merchant to help determine current conditions of the merchant (e.g., how busy the merchant is, how crowded the merchant is, etc.). Historical transaction information associated with similar merchants may also be utilized to determine current conditions of similar merchants. In some embodiments, payment processor data 104(C) may be utilized along with other information to further analyze the trends (e.g., by time of day, day of week, weather conditions, etc.).

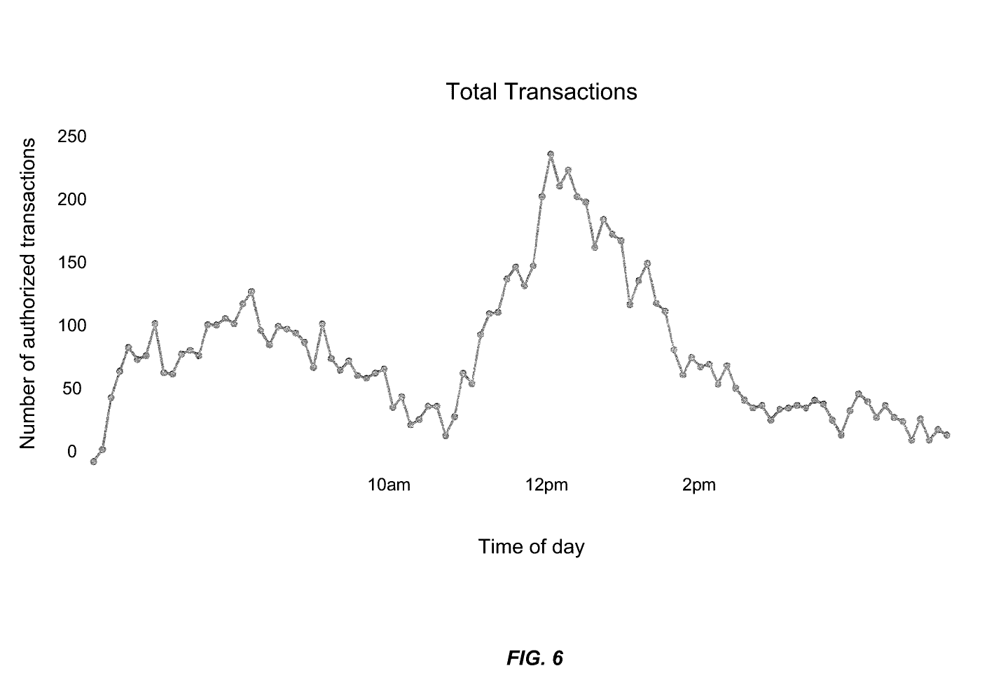

An exemplary graph comprising some payment processor data 104(C) is shown in FIG. 6. The graph shows the number of authorized transactions detected throughout different times of the day (e.g., rate of transaction) on a certain day of the week. Such information may be useful to analyze transaction patterns associated with a merchant, such as a turn-around time associated with a merchant. For example, for a fast-food restaurant assuming rate of food assembly/preparation remains somewhat constant, the transaction rate may be considered high if the merchant is having a busy day (and hence long line and waiting time). On the other hand, the transaction rate may be considered low (or lower than normal) if the merchant is having a less-than busy day. In some cases, such collected data may correspond to specific terminals at a merchant, merchant types, merchant locations, etc. Granularity of data points may be updated to fit any settings configured by payment processing network 104 and mobile application 102(C).

Merchant 103 may be any suitable entity that may be associated with a wait time and any transaction data. Merchant 103 may operate a merchant computer configured to receive transaction data from access device 108. Merchant 103 may engage in transactions, sell goods or services, or provide access to goods or services to user 101. Merchant 103 may accept multiple forms of payment and may use multiple tools to conduct different types of transactions. For example, merchant 103 may operate a physical store and use access device 108 for in-person transactions. Some non-limiting examples of merchant 103 may include restaurants (e.g., sit-down, take-out, drive-through, etc.), cafeterias, gas stations, shopping malls, grocery stores, movie theatres, banks, and automated teller machines.

Merchant 103 may be in communication with payment processing network 104. In some embodiments, merchant 103 may send information to payment processing network 104 that may be stored as part of payment processor data 104(C). In some embodiments, merchant 103 may optionally subscribe to data analytics from payment processing network 104 to enable offers (e.g., discounts, coupons, loyalty points, etc.) to provide to user 101 by mobile application 102(C). Merchant 103 may also sell goods and/or services via a website, and may accept payments over the Internet.

Access device 108 may be any suitable device for communicating with a merchant computer associated with merchant 103 or payment processing network 104, and for enabling interaction with user 101. Some non-limiting examples of access device 108 may include point-of-sale (POS) devices, cellular phones (e.g., mPOS), PDAs, personal computers (PCs), tablet PCs, set-top boxes, virtual cash registers (VCRs) and the like. Access device 108 may use any suitable contact or contactless mode of operation to send or receive data from, or associated with, a payment device of user 101. In some embodiments, access device 108 may be a client computer associated with a merchant.

Payment processing network 104 may be in communication with one or more databases. For example, payment processing network 104 may be in communication with merchant information database 105, user information database 106, and external information database 107. Any combination of information from such databases may be utilized by mobile application modules 104(B) in calculations and to provide notifications to user 101. Such information may help improve wait time predictions. In some embodiments, payment processing network 104 may be in communication with other databases (besides those shown in FIG. 1) comprising any suitable information that can be utilized to implement features of mobile application 102(C).

Merchant information database 105 may comprise any information associated with various merchants. For example merchant information database 105 may comprise merchant name, merchant type, merchant category code, merchant location, related merchant locations, merchant size, merchant opening and closing times, number and locations of payment terminals at merchant, current and historical wait times associated with merchants, and other relevant information. Payment processing network 104 may access merchant information database 105 to location similar merchants in a targeted area. In some embodiments, information surrounding historical wait times associated with merchants may be analyzed against certain factors (e.g., time of day, day of week, weather conditions, traffic conditions, etc.). The analysis results may be utilized to help more accurately predict a wait time requested by user 101.

User information database 106 may comprise any information associated with one or more users. For example, user information database 106 may comprise user feedback regarding wait time predictions, personalized statistics (e.g., wait time that user 101 typically accepts, etc.), user enrollment information, and other relevant information.

External information database 107 may comprise any information that may be retrieved from third parties. For example, external information database 107 may comprise traffic information, weather information, merchant ratings, offers, crowd sourced information, and other relevant information.

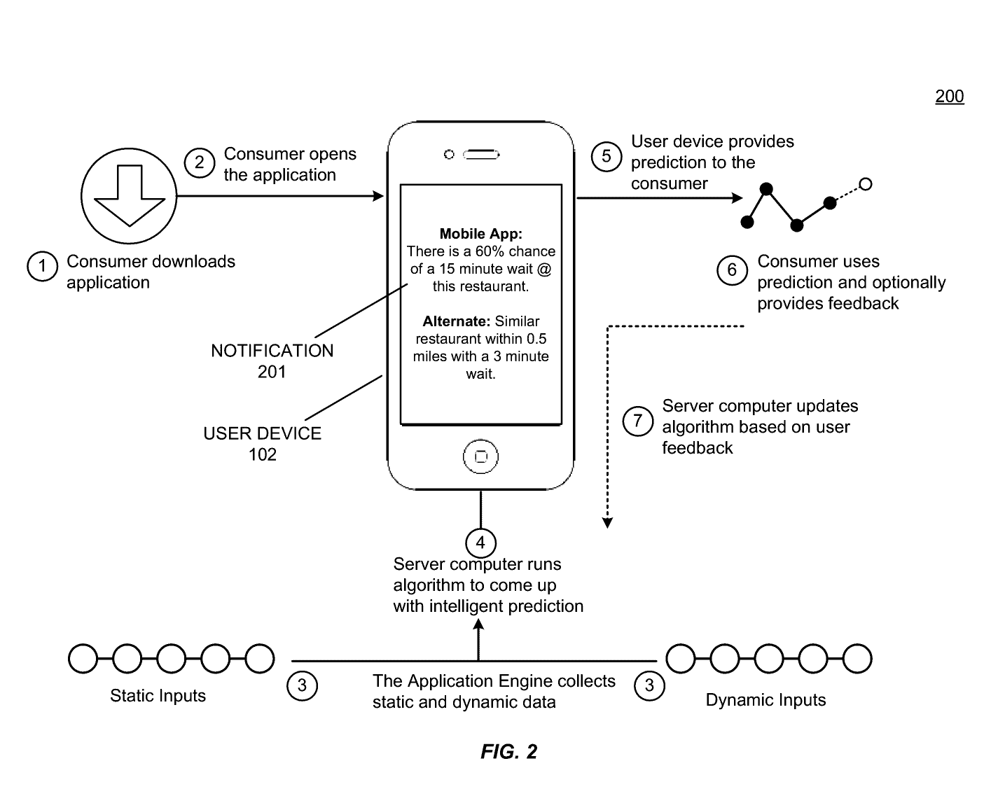

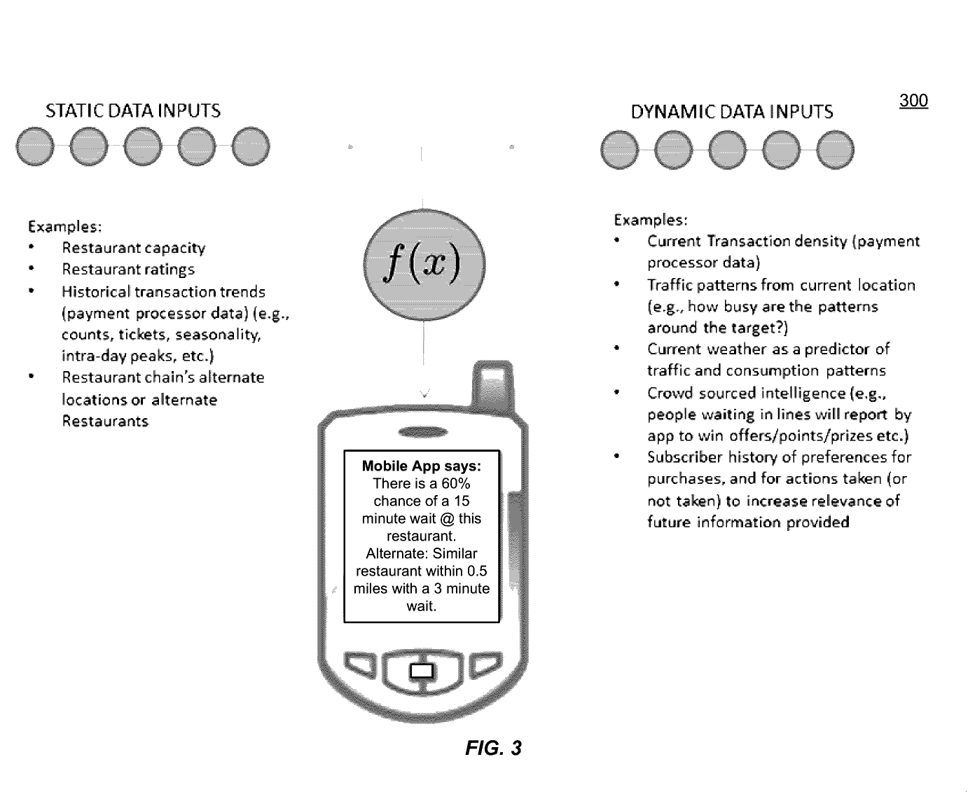

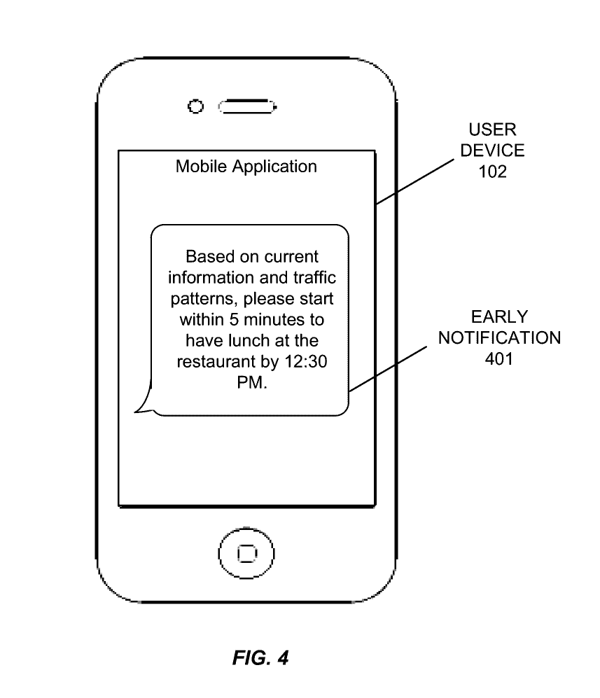

FIG. 2 shows a flowchart 200 of a method according to embodiments of the present invention. The method of FIG. 2 may be performed by one or more components described with reference to FIG. 1, FIG. 3, and FIG. 4.

Additional methods and processes may be included within these methods and may be recognized by one of ordinary skill in the art, in light of the description below. Further, in some embodiments of the present invention, the described methods may be combined, mixed, and matched, as one of ordinary skill would recognize.

At step 1, user 101 (which may alternatively be referred to as a consumer) may download mobile application 102(C) onto user device 102. User 101 may download mobile application 102(C) prior to conducting a transaction with a merchant, such as merchant 103. User 101 may configure settings to enable location information to be sent by user device 102 to payment processing network 104.

At step 2, user 101 may launch mobile application 102(C) to utilize its features, including viewing wait time predictions associated with merchants. In some embodiments, user 101 may interact with an interface of mobile application 102(C) to choose to view information about a certain merchant. For example, user 101 may request to view information including a wait time related to merchant 103. In some embodiments, this may trigger user device 102 to communicate with a server computer, such as payment processing network 104.

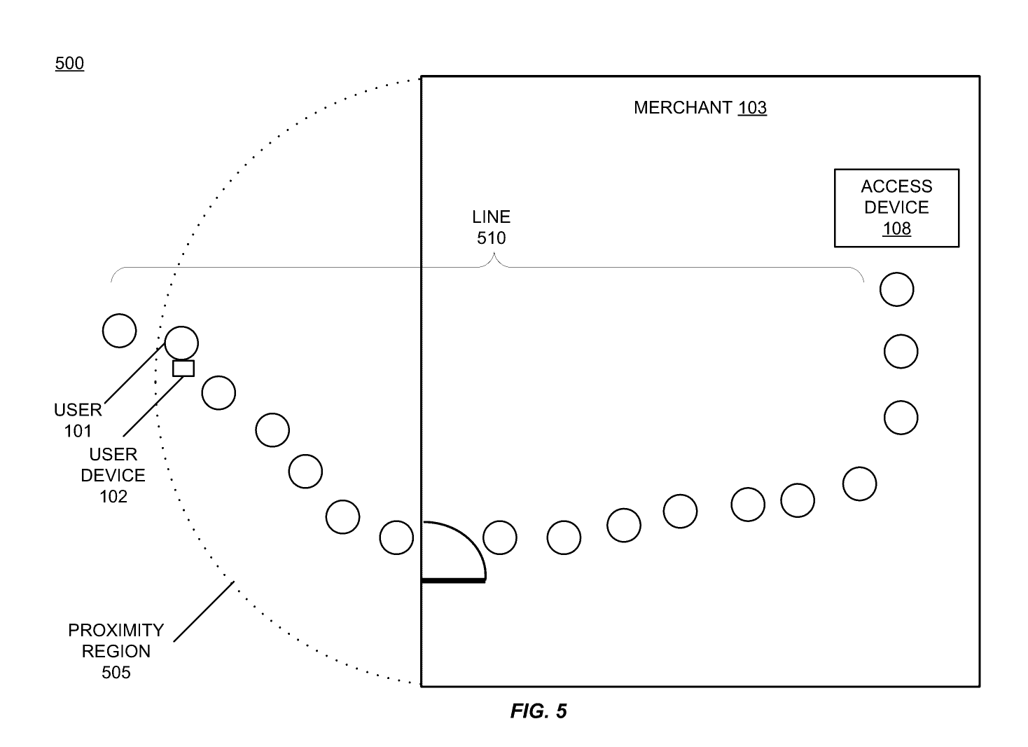

At step 3, mobile application modules 104(B) (e.g., application engine) of payment processing network 104 may collect relevant static and dynamic data. Any of the static and dynamic data may be stored in payment processor data 104(C), one or more databases (e.g., merchant information database 105, user information database 106, external information database 107, etc.), merchant 103, access device 108, and user device 102. Exemplary static and dynamic information may be listed in FIG. 3. In some embodiments, mobile application modules 104(B) may collect location information from GPS 102(B) of user device 102. An exemplary use case of such location information may be described in reference to FIG. 5.

At step 4, payment processing network 104 may run an algorithm utilizing the static and dynamic data as inputs and output an intelligent wait time prediction. Payment processing network 104 may calculate a wait time prediction associated with merchant 103 as requested by user 101. In some embodiments, payment processing network 104 may calculate wait time predictions associated with other nearby merchants or related merchants (e.g., stored in merchant information database 105). Mobile application modules 104(B) of payment processing network 104 may generate an exemplary notification 201 based on the calculated information and send notification 201 to user device 102.

At step 5, user device 102 may receive and display notification 201 to provide information including the wait time prediction associated with merchant 103 to user 101. For example, user 101 may view notification 201 and determine that merchant 103 has a 60% chance of a 15 minute wait, while a second merchant within 0.5 miles has a 3 minute wait. The wait time associated with the merchant may be calculated based on any number of factors. For example, some embodiments of the present invention may utilize any combination of target market trends, consumer-unique data, business intelligence, dynamic data, external data, and solution modeling. In some embodiments, at least a portion of this information may be maintained by the payment processing network 104 depicted in FIG. 1. In some embodiments, at least some of the information may be stored by at least one of the merchant information database 105, the user information database 106, and/or the external information database 107 depicted in FIG. 1

At step 6, user 101 may utilize information provided in notification 201 to choose whether to wait at merchant 103. In some embodiments, user 101 may provide feedback to payment processing network 104 regarding effectiveness of the received information. For example, user 101 may choose to wait at merchant 103 and then afterwards inform payment processing network 104 whether the received predicted wait time associated with merchant 103 was accurate. In some cases, user 101 may enter an actual wait time associated with merchant 103 into the interface of mobile application 102(C) after conducting a transaction. In some embodiments, any information input by user 101 may be received by payment processing network 104 and stored at user information database 106.

In some embodiments, user device 102 may display other notifications to user 101. For example, as shown in FIG. 4, user device 102 may display an early notification 401 comprising information such as when user 101 should start heading to a certain merchant to conduct a transaction at the merchant by a certain time. In some cases, early notification 401 may comprise other relevant information (e.g., traffic patterns, weather information, etc.). This may be useful when user 101 may choose not to wait at merchant 103 and instead choose to go to the second merchant location suggested in notification 201. In some embodiments, GPS 102(B) of user device 102 may detect when user 101 changes locations and may trigger mobile application 102(C) to display relevant notifications.

In some embodiments, a notification displayed by user device 102 may comprise an offer (e.g., discount, coupons, loyalty points, etc.) associated with a merchant. For example, early notification 401 may comprise an offer associated with the second merchant to provide an incentive for user 101 to travel to the second merchant and avoid a wait at merchant 103.

At step 7, payment processing network 104 may utilize information received from user 101 to update the algorithm utilized to determine information (e.g., wait time predictions). For example, payment processing network 104 may store and analyze information received from user 101 (e.g., user feedback, etc.) to improve accuracy of wait time predictions.

While a user-facing mobile application is described in detail above, embodiments are not so limited. For example, mobile application 102(C) may be a merchant-facing application, where user 101 may be a merchant. For example, the merchant may utilize features of mobile application 102(C) to better manage its wait times (e.g., by viewing real-time wait times associated with cash registers, monitoring productivity of cashiers, determining an optimal number or location of terminals to open during a certain time of day, etc.). In some cases, the merchant may also optimize schedules (e.g., opening and closing during certain times of the day or days of the week, etc.) and pricing based on information provided by mobile application 102(C).

FIG. 3 shows exemplary data according to embodiments of the present invention. In accordance with at least some embodiments, various static data inputs may be used to calculate a merchant wait time. For example, the static inputs may include merchant capacity, merchant ratings, historical transaction trends, and/or alternate locations for merchant. As describes elsewhere in this application, this static information may be maintained by the payment processing network 104 depicted in FIG. 1, or by any other entity from which the payment processing network 104 is able to gather data.

In accordance with at least some embodiments, various dynamic data inputs may be used to calculate a merchant wait time. For example, the dynamic data inputs may include current transaction density for a merchant or point of sale, traffic patterns from the current location, weather patterns, crowd sourced intelligence, and/or subscriber history information. This dynamic data may be calculated in real time by the payment processing network 104 depicted in FIG. 1.

FIG. 4 shows an exemplary early notification according to embodiments of the present invention. In this example, a user device 102 may calculate a total time that it will take before a user is able to conduct a transaction with a particular merchant. The total time may be calculated to include a wait time, a drive time (based on traffic patterns between the user and the merchant), and/or walking time (from the user to the merchant).

In some embodiments, merchant may provide an average time-in-store (e.g., an amount of time that the average consumer spends at his or her store). In this example, the notification 401 may include an indication of the time at which the user will likely return to his or her starting location.

FIG. 5 shows an exemplary environment 500 according to embodiments of the present invention. Environment 500 may comprise user 101 operating user device 102, merchant 103, access device 108, a proximity region 505, and a line of consumers 510. FIG. 5 may be described with reference to components of system 100 of FIG. 1.

User 101 may be waiting in line 510 at merchant 103 to conduct a transaction. User 101 may operate user device 102 to view a wait time associated with merchant 103. In an exemplary case, merchant 103 may be a take-out restaurant. Merchant 103 may comprise access device 108 at which user 101 and other consumers may conduct transactions. Payment processing network 104 may be in communication with one or more of user device 102, merchant 103, and access device 108 and may provide real-time wait times to user 101 by mobile application 102(C).

As user 101 is waiting in line 510, user device 102 may send location information associated with user device 102 to payment processing network 104. The location information may be utilized to determine information surrounding user 101. For example, location information from GPS 102(B) may enable detection of when user 101 arrives at merchant 103, how long user 101 is present at merchant 103, when user 101 leaves merchant 103, and other relevant information.

In some embodiments, a proximity region may be utilized to analyze location information from user device 102. As shown in FIG. 5, payment processing network 104 may set proximity region 505 near merchant 103 (e.g., by geo-fencing). Proximity region 505 may indicate where user 101 is located relative to merchant 103. For example, when user 101 first enters proximity region 505, it may be determined that user 101 arrived at merchant 103. When user 101 leaves proximity region 505, it may be determined that user 101 left merchant 103.

In some embodiments, the payment processing network 104 may determine that the user has conducted a transaction at the merchant 103 upon receiving an authorization request message related to that user. For example, if the user utilizes a payment account that is associated with him or her, then the payment processing network 104 may receive an authorization request message related to that payment account. The payment processing network 104 may identify both the user 101 and/or the merchant 103 from the authorization request and may identify a timestamp associated with the authorization request message with a conclusion of a transaction between the user and the merchant.

If a transaction conducted by user 101 is not detected before user device 102 leaves proximity region 505, it may be determined that user 101 decided not to wait at merchant 103. In some implementations, payment processing network 104 may store and utilize this information for analysis (e.g., calculate abandonment rate, etc.), which may affect future wait time predictions. A transaction conducted by user 101 operating user device 102 may be detected by any suitable manner (e.g., associate payment device utilized in transaction with user 101, detect location of access device 108 and location of user device 102, prompt user 101 for confirmation of transaction completion, etc.).

In some cases, payment processing network 104 may store timestamps associated with the times that user 101 entered and left proximity region 505. In some cases, the timestamps may be utilized to keep track of how long user 101 waited in line 510 at merchant 103. As user 101 moves up in line 510 towards access device 108, payment processing network 104 may store and utilize location information from user device 102 along with other relevant information (e.g., transaction rate, average ticket size, etc.) to calculate how fast line 510 is moving.

After user 101 arrives at access device 108, payment processing network 104 may detect that user 101 has conducted a transaction with merchant 103. In some cases, payment processing network 104 may store the time taken from user 101 entering proximity region 505 until the transaction is conducted, and the time taken from user 101 conducting the transaction until leaving proximity region 505. Any stored information may be utilized to improve future calculations of wait time predictions.

A proximity region may be made up of one more regions and may be any suitable shape. For example, proximity region 505 may be an area around an entrance of a merchant or surrounding a merchant location. In some embodiments, proximity region 505 may comprise a portion or the entirety of the inside of a merchant location in combination with an area outside of the merchant location. In some cases, a merchant may be associated with multiple proximity regions (e.g., near multiple entrances, cash registers, etc.).

While merchant 103 is described as a take-out restaurant in the description above, embodiments are not so limited. Merchant 103 may be any entity that may be associated with a wait time. Mobile application 102(C) may take into account the merchant type or other characteristics of merchant 103 when determining information to present to user 101. Location information of user device 102 and proximity region 505 may be utilized in a similar manner as described above to provide information to user 101.

FIG. 6 depicts an example of authorization data that may be received at a payment processing network in accordance with at least some embodiments. In some embodiments, the graph in FIG. 6 may represent the total number of authorization requests that are received from a type of merchant within a vicinity of a user. For example, this graph may represent the total authorization requests received from all Mexican style restaurants within 10 miles of the user. In some embodiments, a payment processing network may take into account the percentage of authorization requests received from a particular merchant and a capacity (e.g., a number of users that the merchant is able to service) in order to determine a relative crowdedness for each restaurant at any given time. In some embodiments, the payment processing network 104 may calculate a current transaction frequency, current transaction volume, average ticket price, and/or an average number of items being purchased from a particular merchant based on this information.

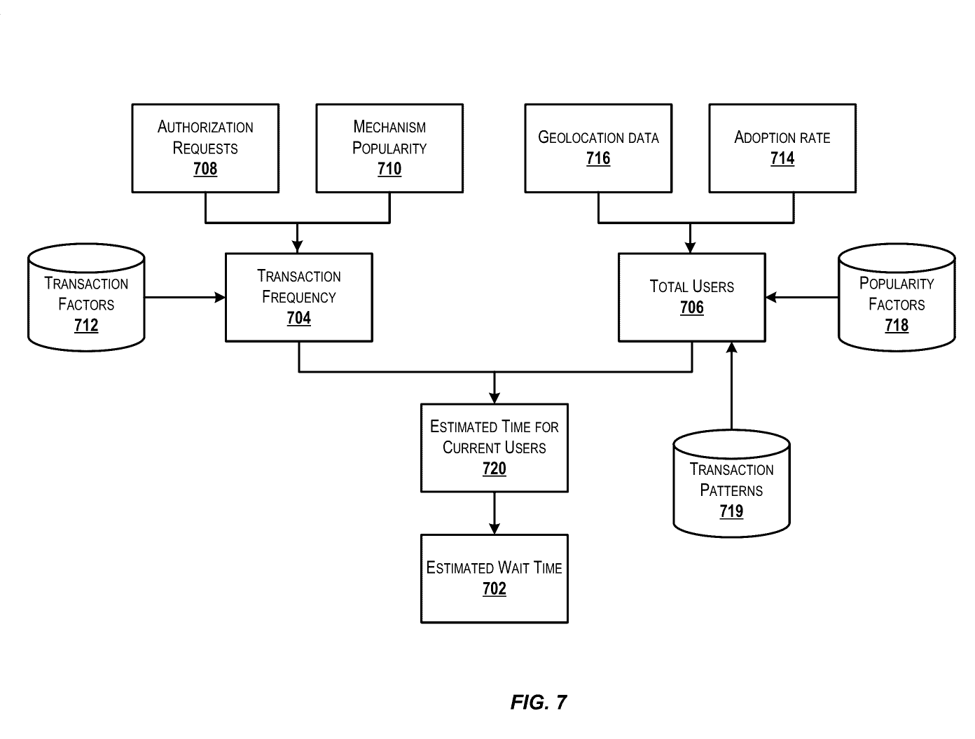

FIG. 7 depicts a data flow illustrating an example technique for providing an estimation of wait time in accordance with at least some embodiments of the disclosure. In FIG. 7, a payment processing network (e.g., the payment processing network 104 depicted in FIG. 1) may calculate an estimated wait time 702 for a resource provider or resource providers. To do this, the payment processing network may estimate a transaction frequency 704 for the resource provider and a total number of users 706 currently at the resource provider.

In some embodiments, the payment processing network may identify a number of authorization requests 708 originating from a particular resource provider (or a particular point of sale within a resource provider) and may estimate the transaction frequency of that resource provider based on the identified authorization requests and a mechanism popularity 710. In this example, the payment processing network may determine that X % of consumers utilize a particular payment method associated with the payment processing network (the mechanism popularity). For example, the payment processing network may determine that 30% of transactions are conducted with cash. Based on the authorization requests 708 and the mechanism popularity 710, the payment processing network may extrapolate an estimated transaction frequency. In a simple example, the payment processing network may divide the number of authorization requests received for a resource provider over a time period (e.g., the last ten minutes) by the mechanism popularity to estimate a total number of transactions that have likely been conducted during that time period. The total number of transactions may then be divided by the amount of time in the time period to determine a transaction frequency. It should be noted that, in a more complex example, additional transaction factors 712 may be used to increase the accuracy of the transaction frequency estimate. For example, the transaction factors may include historical data that may influence the calculation. In particular, the transaction factors may include an adjustment to be made to the mechanism popularity based on a historical mechanism popularity specific to the resource provider.

By way of illustration, consider the scenario in which the payment processing network is VisaNet and has access to all authorization request messages originating from a particular resource provider in which a Visa credit card (or other Visa account) is provided as the payment mechanism. Currently, Visa accounts are used to pay for approximately 52.4% of transactions by consumers (Visa's mechanism popularity). In the above scenario, VisaNet may identify 22 authorization request messages that have been received within the last 10 minutes from Resource Provider A. Accordingly, VisaNet may estimate that Resource Provider A has likely conducted approximately 42 transactions total (22 transactions divided by 0.524) in the last 10 minutes, for a transaction frequency of 4.2 transactions per minute (42 transactions divided by 10 minutes). It should be noted that any number of factors may influence this estimate. For example, Visa may be the only payment mechanism that the resource provider accepts, meaning that consumers are required to use either Visa or cash. In this example, VisaNet may alter its estimates to take into account the fact that Visa is likely being used in a higher number of transactions than average, which would result in a lower estimated number of total transactions and subsequently a lower transaction frequency.

In accordance with at least some embodiments, the payment processing network may estimate a total number of users 706 that are in line at a particular resource provider. In some embodiments, the payment processing network may determine an adoption rate 714 of the mobile application (depicted as mobile application 102(C) in FIG. 1). An adoption rate may be a percentage of the population that has adopted (e.g., downloaded and/or executed) a mobile application. The adoption rate may be calculated with respect to a particular location and/or segment of the population. For example, the payment processing network may determine that X unique users have downloaded the application in an area with Y total residents of age 18 and over (according to data released by the U.S. Census Bureau or any other suitable population-related data) for an adoption rate of X/Y. The payment processing network may also receive geolocation data 716 from one or more of the users of the mobile device. The adoption rate, paired with the location data received from various users of the mobile application, may then be used to estimate a total number of users currently at a particular resource provider. For example, the number of users at a particular location divided by the adoption rate may yield a rough estimate of the total number of users at the particular location.

In some embodiments, the total number of users may be estimated using transaction patterns 719. In some embodiments, the payment processing network may track authorization requests received in relation to one or more transactions conducted by one or more users. In particular, the payment processing network may identify a transaction pattern (e.g., a series of transactions that are typically conducted) for a particular user or users based on authorization requests received in relation to that user. For example, a user may often conduct a first transaction with a first resource provider which is followed by a second transaction with a second resource provider. In this example, a transaction pattern may be stored with relation to the first and second transaction and the user. In some embodiments, a transaction pattern may be stored with an indication of a probability (e.g., this transaction pattern is exhibited 60% of the time that a user conducts the first transaction, hence, there is a 60% chance, upon detecting the first transaction, that the user will conduct the second transaction). In some embodiments, the payment processing network may determine a probability that a number of users will visit the second resource provider. In some embodiments, the payment processing network may also determine an estimated wait time based on a time between transactions as maintained in the transaction pattern.

It should be noted that other popularity factors 718 may influence this calculation. For example, historical resource provider data may indicate that the adoption rate for users that visit a particular resource provider is typically higher or lower than the average adoption rate for the area. In another example, multiple adopters of the mobile application may be associated with each other (e.g., these two users usually go to lunch together, etc.) such that the estimate of total users might be adjusted downward. Other factors may also play a role. For example, weather patterns may be used if the resource provider is more or less popular on days with particular weather. By way of illustration, a restaurant with an outdoor patio dining area may be more popular on sunny days. Once estimated, the total number of users may then be divided by the transaction frequency to estimate an amount of time that it will take to process the current number of users at that resource provider 720. In some embodiments, the payment processing network may add to that time an amount of time per transaction to calculate an estimated wait time 702.

Continuing with the above illustration in which the payment processing network is VisaNet, VisaNet may determine an adoption rate of 8% for the area in which Resource Provider A is located. Additionally, VisaNet may determine that there are currently 6 adopters of the mobile device at Resource Provider A (based on geographic data received from mobile devices of the adopters). In a simple example (assuming no other relevant factors), VisaNet may estimate a total of 75 consumers at Resource Provider A (6 adopters divided by the adoption rate of 0.08). At a transaction rate of 4.2 transactions per minute (explained above), VisaNet may estimate that the current line will take approximately 17.9 minutes (17 minutes, 54 seconds) to get through. Additionally, VisaNet may add to this estimate an amount of time that it would take the user to conduct an additional transaction. For example, at a transaction rate of 4.2 transactions per minute, each transaction is estimated to take approximately 0.24 minutes (14.29 seconds). In this example, the user would likely complete his or her transaction in approximately 18 minutes and 8 seconds.

In accordance with at least some embodiments, a user may provide feedback based on an accuracy of the estimated wait time. For example, the wait time may be presented to the user and the user may be provided with the ability to select a time at which the transaction has been completed. In some embodiments, the payment processing network may identify an authorization request related to the user that is received from the resource provider and may automatically enter feedback based upon the time at which the authorization request is received. Upon detecting that the estimated time varies greatly from the actual time of the transaction, the payment processing network may update one or more variables used to estimate the wait time.

In some embodiments, the user may be provided with an offer based on the wait time for a particular merchant. In some embodiments, the offer may pertain to an incentive to go to a second resource provider. In some embodiments, the offer may pertain to an incentive to stay in line at the current resource provider. In some cases, the offer may be determined based on the calculated wait time. For example, a user may be provided with an offer that is proportional to the wait time of the line that the user is currently waiting in. By way of illustration, a resource provider may, upon calculating a current wait time associated with its line, determine an appropriate incentive to offer. In this illustrative example, the resource provider may offer a greater incentive for users to remain in line if the line is longer than it offers to users when the line is shorter (e.g., 10% off of a purchase for waiting in a 10 minute line versus 15% off a purchase for waiting in a 20 minute line). In another illustrative example, the user may be presented with an offer related to a second resource provider of a similar resource to that provided by the resource provider for which the user is currently in line.

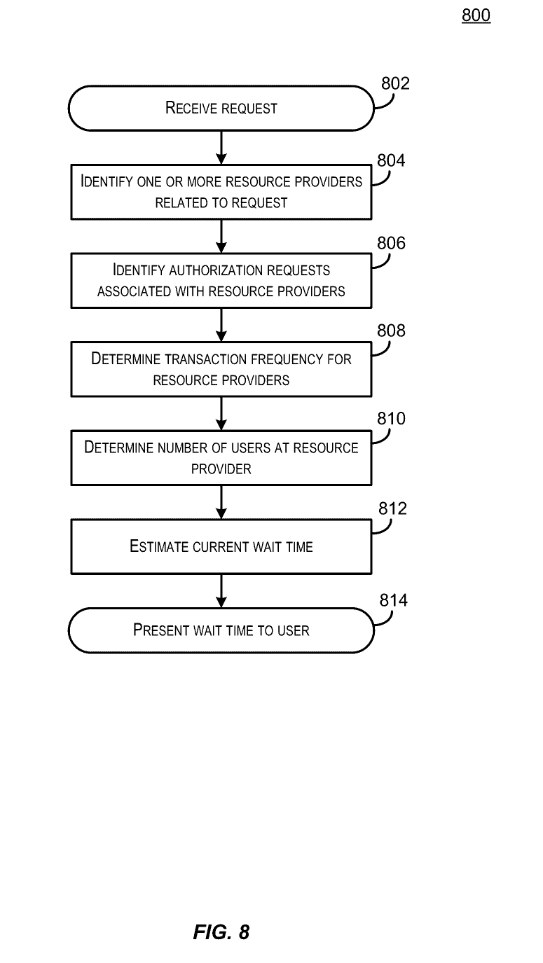

FIG. 8 depicts a flow diagram illustrating an example process 800 for identifying a wait time to be presented to a user. Some or all of any of the processes described herein (or variations and/or combinations thereof) may be performed under the control of one or more computer systems configured with executable instructions and may be implemented as code (e.g., executable instructions, one or more computer programs or one or more applications). In accordance with at least one embodiment, the process 800 of FIG. 8 may be performed by the payment processing network 104 depicted in FIG. 1. The code may be stored on a computer-readable storage medium, for example, in the form of a computer program including a plurality of instructions executable by one or more processors. The computer-readable storage medium may be non-transitory.

In accordance with at least some embodiments, process 800 may begin at 802 when a request is received to provide one or more wait times associated with at least one resource provider. In some embodiments, the request may include an indication of a specific resource provider or type of resource provider to which the request is related. For example the request may include an indication that the user wishes to view wait times of local coffee shops.

At 804, the process 800 may identify one or more resource providers related to the request. In some embodiments, a user may provide an indication of a resource provider (e.g., the user selects a resource provider from a list, inputs a resource provider name or identifier, etc.). In some embodiments, the user may input a type of resource provider (e.g., a provider of a particular good and/or service) and the payment processing network may identify one or more of the type of resource provider within a vicinity of the user. In some embodiments, an implementation of the disclosure may be specific to a particular resource provider or type of resource provider.

At 806, once at least one resource provider has been identified, the process may identify authorization requests or other transaction data related to the resource provider. For example, if the user has indicated a particular type of resource provider, then the process may identify all authorization requests with a particular merchant category code associated with the indicated resource provider type. In another example, the process may query a database of resource provider identifiers in order to identify all authorization requests related to the resource provider.

At 808, a transaction frequency may be calculated based on this transaction data (e.g., a number of transactions that are being processed within a predetermined period of time). In some embodiments, this data may be provided by the resource provider itself. For example, the resource provider may include a point of sale device that tracks the transaction frequency at a given time. The point of sale device may be configured to communicate a transaction frequency to another entity (e.g., the payment processing network). In some embodiments, the transaction frequency may be calculated as a number of transactions conducted by the resource provider over a given timeframe. The timeframe may be any predetermined amount of time. For example, the timeframe may be one minute, five minutes, one hour, one day, etc.

At 810, a number of users currently at the resource provider may be estimated. In some embodiments, this may be done using historical data. For example, the number of users may be estimated based on a total number of users at the store on the same day one year ago, the same day of the week in the previous week, the same time on the day before, etc. In some embodiments, the total number of users at the resource provider may be calculated based on an adoption rate of a mobile implementation of the disclosure and geolocation data associated with users of the mobile implementation. In some embodiments, the total number of users at the resource provider may be estimated based on detected transaction patterns.

At 812, a wait time may be estimated based on the current number of users at the resource provider and the transaction frequency. For example, by dividing the total number of users at the resource provider by the transaction frequency, it may be determined how quickly the current line may be processed at the calculated transaction frequency. In some embodiments, the amount of time to process an average transaction may be added to this time (representing the time that it will take the user to conduct a transaction). At 814, the wait time may be presented to the user.

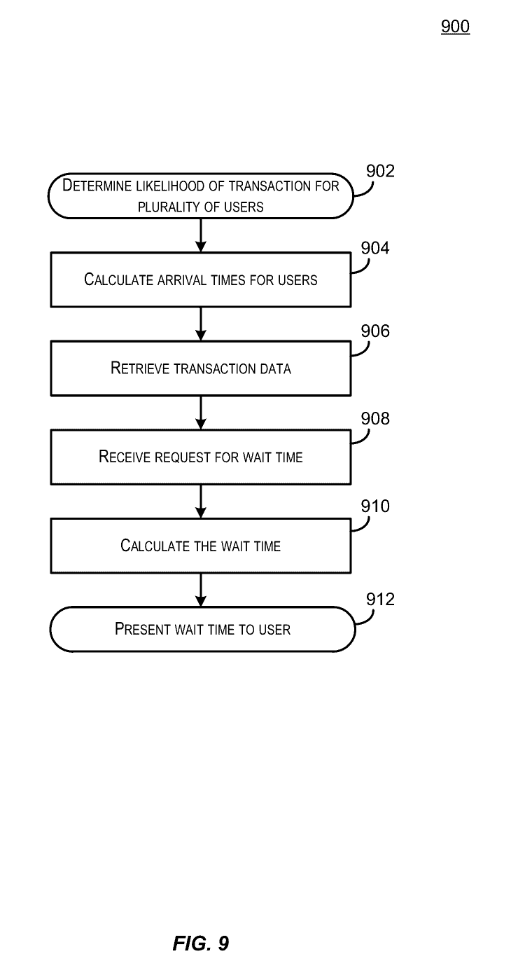

FIG. 9 depicts a flow diagram illustrating an example process 900 for identifying a wait time to be presented to a user based on transaction pattern data. In accordance with at least one embodiment, the process 900 of FIG. 9 may be performed by the payment processing network 104 depicted in FIG. 1.

Process 900 may begin at 902, when it is determined that a user or a plurality of users are likely to visit a resource provider. In some embodiments, the process 900 may identify transaction patterns related to a probability that a user will visit the resource provider. For example, transaction patterns may indicate a series of resource provider transactions, such that a transaction at a first resource provider is often followed by a transaction at the second resource provider. In this example, detecting an authorization request message that indicates a transaction has been conducted at the first resource provider may indicate that the user that conducted the transaction is likely to visit the second resource provider as well. In some embodiments, this may be universal to all users (e.g., 80% of users that conducted a transaction at a first resource provider conducted a transaction at the second resource provider within 10 minutes) or it may be specific to a particular user (e.g., 90% of the time, this user follows a first transaction at the first resource provider with a second transaction at the second resource provider). In some embodiments, transaction patterns may be based on geographic location. For example, it may be determined that 65% of the users that enter a geographic vicinity conduct a transaction at a resource provider. In this example, the process 900 may, upon detecting a user entering a geographic vicinity, estimate a 65% chance that the user will conduct a transaction at the resource provider.

At 904, an arrival time may be estimated for each user predicted to visit the resource provider. In some embodiments, a transaction pattern may be associated with a time between transactions. For example, if transactions with two separate resource providers are often correlated (e.g., a transaction with one of the resource providers often follows a transaction with another of the resource providers), then the arrival time may be calculated as an average amount of time that typically transpires between the two transactions. In some embodiments, the arrival time may be calculated as a travel time (e.g., a function of the distance between the two resource providers). For example, a travel time may represent an amount of time that it would take an average person to travel from a first resource provider to a second resource provider given the distance between the two resource providers.

At 906, transaction data related to the resource provider may be retrieved. In some embodiments, the transaction data may comprise authorization requests submitted by the resource provider. In some embodiments, the transaction data may comprise an estimate of the number of authorization requests received in relation to authorization requests received from other resource providers. For example, it may be determined that Resource Provider A is submitting authorization requests at twice the rate of Resource Provider B. In some embodiments, the transaction data may include historical data related to a relative number of authorization requests submitted by each resource provider. In some embodiments, a transaction frequency may be calculated based on the transaction data.

At 908, a request may be received for a wait time associated with the resource provider. For example, a user may submit a request for a wait time with respect to a resource provider. In some embodiments, this may be done by executing a mobile application installed on a user's mobile device. Upon execution, the location of the mobile device may be provided to a server that supports the mobile application (e.g., payment processing network 104 depicted in FIG. 1).

At 910, the requested wait time may be calculated. To do this, the process may predict, based on the transaction patterns identified at 902, a number of users that are likely to arrive at the resource provider before the user. In addition, the amount of time that the number of users would take to be processed may be calculated using the transaction frequency calculated at 906.

At 912, the calculated wait time may be presented to the user. In some embodiments, the wait time may be presented along with a probability. For example, a provided notification may state that there is an 80% chance of a 12 minute wait time. In some embodiments, multiple wait times may be presented for multiple resource providers.

By way of illustration of process 900, consider a scenario in which transaction patterns are tied to transactions occurring at a food court (a geographic location). In this example, it may be determined (e.g., based on relative number of authorization requests for each restaurant in the food court), that 20% of the users who enter the food court conduct a transaction at Restaurant A, 35% conduct a transaction at Restaurant B, 30% conduct a transaction at Restaurant C, and 15% do not conduct a transaction. From this transaction pattern, the process may determine that if 10 users are detected entering the food court (based on geographic data provided by a mobile device), that it is likely that 2 of them will conduct a transaction at Restaurant A. In some embodiments, an adoption rate and geographic data may be used (i.e., in the fashion described above with respect to FIG. 8) to estimate a number of users entering the food court. Continuing with this example, a transaction frequency may be calculated for Restaurant A based on the number of authorization requests that have been received in the last few minutes. By way of illustration, consider that 6 transactions have been conducted in the last 2 minutes. In this example, the transaction frequency is 3 transactions per minute. Based on this analysis, it would be determined that it should take approximately 40 seconds (⅔ of a minute) for Restaurant A to process the two users who just entered the food court.

By way of a second illustration, consider a scenario in which a transaction pattern indicates that 85% of the time, users who conduct a transaction at a bakery also conduct a transaction at a coffee shop next door. In this example, each authorization request received from the coffee shop may indicate that there is an 85% chance that a subsequent transaction may be conducted at the bakery and vice versa. When an authorization request is received for either of these resource providers, it may first be determined whether a transaction has already been conducted by the user at the other resource provider by querying for an authorization request from that user submitted by the other resource provider. If no such authorization request has been received, then it may be estimated that there is an 85% chance that the user will visit the other resource provider next. In this scenario, the transaction pattern may also be associated with a time between transactions. The time between transactions may be used to estimate when the user will arrive at the subsequent resource provider. Based on this information, upon detecting authorization requests from the coffee shop, an estimate may be calculated for the number of users that are likely to conduct a transaction at the bakery. The transaction frequency may then be calculated based on the number of authorization requests that have been received from the resource provider in the last few minutes. Based on the transaction frequency, an estimate of the amount of time that it will take to process the predicted transactions may be calculated as a wait time associated with the resource provider.

Embodiments of the invention provide several advantages. For example, typical systems may have access to only a subset of transaction information (e.g., subset of cardholder transaction information, resource provider, or acquirer information, etc.), which may not be sufficient to provide comprehensive wait time predictions across multiple resource providers. However, the present invention comprises a system comprising at least a payment processing network, a user device, a resource provider, an access device, and databases. This system can enable access to real-time transaction data (data related to transactions conducted within a predetermined period of time) along with other dynamic and static data, which may ensure predictions of wait times and other relevant information that are more timely and accurate. In addition, in embodiments which rely on authorization request data provided to a payment processing network, this disclosure requires no data from the resource provider itself. This means that, unlike other systems in which data must be obtained from a resource provider itself, this disclosure enables a system in which the resource provider need not be an active participant.

A computer system may be used to implement any of the entities or components described above. The subsystems used to implement the disclosure may be interconnected via a system bus. Additional subsystems such as a printer, keyboard, fixed disk (or other memory comprising computer readable media), monitor, which is coupled to display adapter, and others may be used. Peripherals and input/output (I/O) devices, which couple to an I/O controller (which can be a processor or other suitable controller), can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer readable medium. In some embodiments, the monitor may be a touch sensitive display screen.

A computer system can include a plurality of the same components or subsystems, e.g., connected together by external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed:

1. A method comprising:
determining, by a server computer, the likelihood that a plurality of users will each conduct a transaction with a resource provider at a location based on historical transaction pattern data associated with the plurality of users;
calculating, by the server computer, arrival time estimates of each of the plurality of users at the location;
retrieving, by the server computer, transaction data associated with the resource provider conducted within a predetermined time;
receiving, by the server computer, a request from a user device for a wait time associated with the resource provider;
calculating, by the server computer, the wait time based on the arrival time estimates and the transaction data; and
sending, by the server computer, a notification indicating the wait time to the user device.

2. The method of claim 1, wherein the notification includes an offer.

3. The method of claim 2, wherein the offer pertains to an incentive to go to a second resource provider.

4. The method of claim 2, wherein the offer pertains to an incentive to remain in line at the resource provider.

5. The method of claim 4, wherein an amount of the incentive to remain in line at the resource provider is correlated to the calculated wait time.

6. The method of claim 1, wherein historical transaction pattern data associated with the plurality of users comprises patterns of conducted transactions associated with each of the plurality of users.

7. The method of claim 6, wherein determining that there is a high likelihood that a plurality of users will each conduct a transaction with a resource provider comprises detecting an authorization request for an initial transaction of a pattern of conducted transactions for each of the plurality of users.

8. The method of claim 7, wherein the initial transaction of the transaction pattern is a transaction with at least one second resource provider, and the arrival time estimate of a user of the plurality of users is calculated based on a time between transactions in the pattern of conducted transactions.

9. The method of claim 1, wherein the request from a user device for a wait time associated with the resource provider is received upon detecting that the user device has entered within a geographic proximity of the resource provider.

10. A method comprising:
receiving, by a server computer, a request from a user of a user device for a wait time;
identifying a plurality of resource providers related to the received request;
retrieving transaction data associated with the plurality of resource providers, the transaction data indicating a number of authorization requests submitted by each of the plurality of resource providers;
calculating, based at least in part on the transaction data, a wait time for each of the plurality of resource providers; and
sending, by the server computer to the user device, a notification including the wait times.

11. The method of claim 10, further comprising receiving, by the server computer, location information associated with the user device, wherein the plurality of resource providers is identified based on geographic location.

12. The method of claim 10, wherein the request is received upon detecting that the user device is within a proximity region.

13. The method of claim 10, wherein calculating the wait time for the plurality of resource providers comprises:
estimating a transaction frequency associated with each resource provider of the plurality of resource providers based on the transaction data;
estimating a number of users at each resource provider of the plurality of resource providers;
determining an amount of time to process the number of users based on the transaction frequency; and
adding an average transaction time to the amount of time to process the number of users.

14. The method of claim 13, wherein the transaction frequency associated with each resource provider of the plurality of resource providers is estimated based on a mechanism popularity and authorization requests received from the resource provider.

15. The method of claim 13, wherein the number of users at each resource provider of the plurality of resource providers is estimated based on an adoption rate for a mobile application installed on the user device and geographic location data received from a plurality of user devices.

16. A server computer comprising:
one or more processors; and
a memory including instructions that, when executed by the one or more processors, cause the one or more processors to:
receive a request from a user device for a wait time associated with a resource provider;
retrieve transaction data associated with the resource provider, the transaction data indicating transaction patterns exhibited by one or more users;
calculate, based at least in part on the transaction data, the wait time for the resource provider; and
send a notification to the user device that includes the wait time.

17. The server computer of claim 16, wherein the instructions further cause the one or more processors to:
identify a second resource provider associated with the request;
calculate, based at least in part on transaction data for the second resource provider, a second wait time for the second resource provider, wherein the notification also includes the second wait time.

18. The server computer of claim 16, wherein the instructions further cause the one or more processors to receive location data from the user device, the location data including an indication of a current location of the user device, wherein the wait time for the resource provider is calculated to include travel time from the current location to the resource provider.

19. The server computer of claim 18, wherein the notification sent to the user device also includes an indication of a time that the user should leave by to arrive at the resource provider by a requested time.

20. The server computer of claim 18, wherein the notification sent to the user device also includes a probability associated with the calculated wait time.
